(19) United States
(12) Patent Application Publication
(10) Pub. No.: US 2023/0172165 A1
(43) Pub. Date: Jun. 8, 2023

(54) Quick Release Animal Leash Device

(71) Applicant: Raul Silvas, Lubbock, TX (US)

(72) Inventor: Raul Silvas, Lubbock, TX (US)

(21) Appl. No.: 18/055,858

(22) Filed: Nov. 16, 2022

Related U.S. Application Data
(60) Provisional application No. 63/281,888, filed on Nov. 22, 2021.

(51) Int. Cl. A01K 27/00

(52) U.S. Cl. CPC A01K 27/003

(57) ABSTRACT

The present invention relates to a quick-release animal leash device that can easily be secured to an animal collar and does not require that a user bend over to remove the device from a collar. The device is primarily comprised of a body having a first end, a second end comprised of at least one loop, and at least two fasteners. The body can be fed through a collar of an animal between the collar and the animal. Further, the body can then be secured to itself via the fasteners which are preferably positioned near the middle of the body. In this manner, the fasteners can be removed from each other while a user is still standing, and the device can be pulled out from between the animal and the collar while the user is still standing.

### CROSS-REFERENCE TO RELATED APPLICATION

The present application claims priority to, and the benefit of, U.S. Provisional Application No. 63/281,888, which was filed on Nov. 22, 2021, and is incorporated herein by reference in its entirety.

### FIELD OF THE INVENTION

The present invention relates generally to the field of animal leashes. More specifically, the present invention relates to a quick-release animal leash device. The device is primarily comprised of a body having a first end, a second end comprised of at least one loop, and at least two fasteners. The body can be fed through a collar of an animal between the collar and the animal. Further, the body can then be secured to itself via the fasteners which are preferably positioned near the middle of the body. In this manner, the fasteners can be removed from each other while a user is still standing, and the device can be pulled out from between the animal and the collar while the user is still standing. Accordingly, the present disclosure makes specific reference thereto. Nonetheless, it is to be appreciated that aspects of the present invention are also equally applicable to other like applications, devices, and methods of manufacture.

### BACKGROUND

Many animals, especially dogs, are walked on a leash. On a walk, a leash is typically secured to the collar and/or harness of a dog. Existing dog harnesses/collars typically feature a ring that a fastener of the leash can be clipped to. Typically leash fasteners are in the form of a clip. However, clips may be hard to use for individuals with limited hand mobility due to injury, old age, arthritis, etc. In addition, it may take a substantial amount of time and effort to attempt to clip a leash to a dog collar of an unruly or excited dog. This relates to the dexterity required to clip the leash to the collar. Furthermore, an individual must bend down to release a leash clip from a collar. This can be challenging for individuals with limited mobility due to injury, old age, arthritis, etc.

Therefore, there exists a long-felt need in the art for an improved animal leash. There also exists a long-felt need in the art for a quick-release animal leash device that can be easily attached to a collar. Further, there exists a long-felt need in the art for a quick-release animal leash device that can be easily attached to a collar that does not require high levels of physical dexterity. In addition, there exists a long-felt need in the art for a quick-release animal leash device that does not require that a user bend down to release the leash from a collar.

The subject matter disclosed and claimed herein, in one embodiment thereof, comprises a quick-release animal leash device. The device is primarily comprised of a body having a first end, a second end comprised of at least one loop, and at least two fasteners. The body can be fed through a collar of an animal between the collar and the animal. The body can then be secured to itself via the fasteners. The fasteners are preferably positioned near the middle of the body such that the fasteners can be removed from each other while a user is still standing. Once unsecured, the device can then be pulled out from between the animal and the collar while the user is still standing.

In this manner, the quick-release animal leash device of the present invention accomplishes all the foregoing objectives and provides an improved animal leash that can be easily attached to a collar. To accomplish this, the device does not require high levels of physical dexterity to be attached to a collar. The device also does not require that a user bend down in order to release the leash from a collar.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a quick-release animal leash device primarily comprised of a body having a first end, a second end comprised of at least one loop, and at least two fasteners. In differing embodiments, the body may be made from a plurality of materials. Said materials may include, but are not limited to, leather, nylon, chain, cotton, etc. The body may also be any length known in the art.

The body is comprised of a top surface and a bottom surface. At the first end, the top surface is comprised of at least one fastener. Similarly, the bottom surface is comprised of at least one fastener. The first end is also comprised of at least one fastener that is preferably, but not limited to, a ring fastener. The fastener allows the body to be looped under a collar and back through the fastener toward the loop. Then, the bottom surface fastener can be secured to the top surface fastener. In this manner, the device is then secured to the collar.

At least one of the fasteners is preferably positioned near the middle of the body such that it can be unsecured easily while a user is standing. This eliminates the need to bend over to remove the leash from a collar like with existing animal collars. Once unfastened, the device can simply be pulled out from under the collar.

The second end of the device is comprised of at least one loop. The loop allows the device to be easily held. The loop may be comprised of at least one grip area comprised of a padding for comfort.

The device is also comprised of a method of use wherein the body is first placed underneath and through a collar on an animal. Then, the body is pulled toward the loop. Next, the body is secured to itself (and around the collar) by fastening the fastener of the bottom surface to the fastener of the top surface. Once a user desires to remove the device from a collar, they can then separate the fasteners and pull the body out from between the collar and the animal by pulling the loop and/or body.

Accordingly, the quick-release animal leash device of the present invention is particularly advantageous as it provides an improved animal leash that can be easily attached to a collar. To accomplish this, the device does not require high levels of physical dexterity to be attached to a collar and does not require that a user bend down in order to release the leash from a collar. In this manner, the quick-release animal leash device overcomes the limitations of existing animal leashes known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a quick-release animal leash device of the present invention in accordance with the disclosed architecture;

FIG. 2 illustrates a perspective view of one potential embodiment of a quick-release animal leash device while attached around a collar of an animal of the present invention in accordance with the disclosed architecture; and

FIG. 3 illustrates a flowchart of a method of using one potential embodiment of a quick-release animal leash device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved animal leash. There also exists a long-felt need in the art for a quick-release animal leash device that can be easily attached to a collar. Further, there exists a long-felt need in the art for a quick-release animal leash device that can be easily attached to a collar that does not require high levels of physical dexterity. In addition, there exists a long-felt need in the art for a quick-release animal leash device that does not require that a user bend down in order to release the leash from a collar.

The present invention, in one exemplary embodiment, is comprised of a quick-release animal leash device. The device is primarily comprised of a body having a first end, a second end comprised of at least one loop, and at least two fasteners. The body may be made from a plurality of materials including, but is not limited to, leather, nylon, chain, cotton, etc. The body may also be any length known in the art.

The body is comprised of a top surface and a bottom surface. At the first end, the top surface is comprised of at least one fastener. The bottom surface is comprised of at least one fastener. The first end is also comprised of at least one fastener that is preferably, but not limited to, a ring fastener that allows the body to be looped under a collar and back through the fastener toward the loop. Then, the bottom surface fastener can be secured to the top surface fastener. In this manner, the device is then secured to the collar.

The fasteners are preferably positioned near the middle of the body. As a result of this placement, the device can be unsecured easily while a user is standing. This eliminates the need to bend over to remove the leash from a collar like with existing animal collars. Once unfastened, the device can simply be pulled out from under the collar.

The second end of the device is comprised of at least one loop. The loop allows the device to be easily held. The loop may be comprised of at least one grip area comprised of a padding for comfort.

The device is also comprised of a method of use wherein the body is first placed underneath and through a collar on an animal. The body is then pulled toward the loop. Next, the body is secured to itself (and around the collar) by fastening the fastener of the bottom surface to the fastener of the top surface. Once a user desires to remove the device from a collar, they can then separate the fasteners and pull the body out from between the collar and the animal by pulling the loop and/or body.

Accordingly, the quick-release animal leash device of the present invention is particularly advantageous as it provides an improved animal leash that can be easily attached to a collar. To accomplish this, the device does not require high levels of physical dexterity to be attached to a collar and does not require that a user bend down in order to release the leash from a collar. In this manner, the quick-release animal leash device overcomes the limitations of existing animal leashes known in the art.

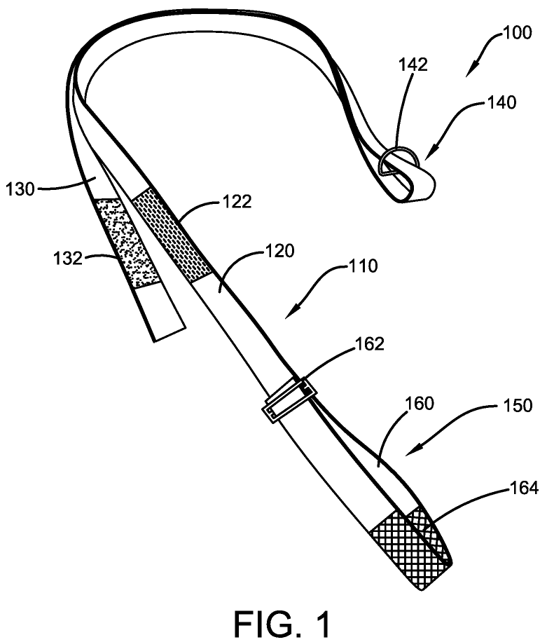

Referring initially to the drawings, FIG. 1 illustrates a perspective view of one potential embodiment of a quick-release animal leash device 100 of the present invention in accordance with the disclosed architecture. The device 100 is primarily comprised of a body 110 having a first end, a second end 150 comprised of at least one loop 160, and at least two fasteners 122,132. In differing embodiments, the body 110 may be made from a plurality of materials. Said material may include, but is not limited to, leather, nylon, chain, cotton, etc. The body 110 may also be any length known in the art.

The body 110 may also be made from an elastic material. The elastic material prevents a user from being injured by a sudden pull of the body 110 by an animal 5. This is accomplished by the elastic material absorbing the shock of the pull.

In one embodiment, the body 110 is made from a reflective material. In another embodiment, the body 110 is made from a phosphorescent material. Both embodiments allow the device 100 to be easily seen at night. This adds improved safety if walking an animal using the device 100 at night.

The body 110 is comprised of a top surface 120 and a bottom surface 130. At the first end 140, the top surface 120 is comprised of at least one fastener 122. Similarly, the bottom surface 130 is comprised of at least one fastener 132.

The first end 140 is also comprised of at least one fastener 142 that is preferably, but not limited to, a ring fastener. The fastener 142 allows the body 110 to be looped under a collar 10 and back through the fastener 142 toward the loop 160. Then, the bottom surface fastener 132 can be secured to the top surface 120 fastener 122. In this manner, the device 100 is then secured to the collar 10.

The fasteners 122,132 are preferably reciprocating fasteners. The fasteners 122,132 may be any type of reciprocating fasteners known in the art. This includes, but is not limited to, hook and loop, magnet, snap button, zipper, etc.

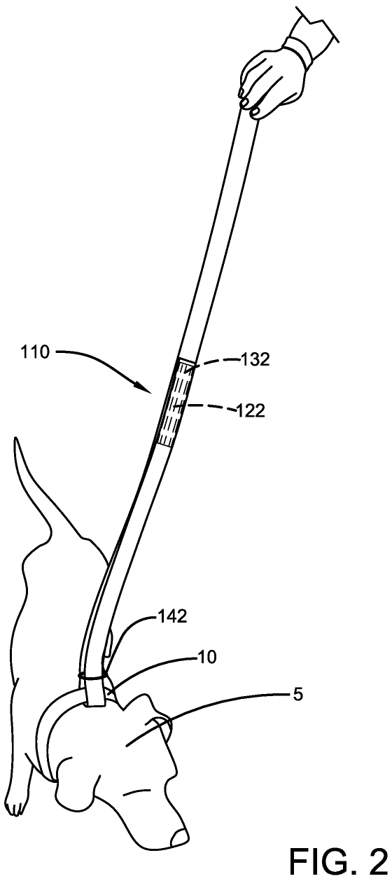

FIG. 2 illustrates a perspective view of one potential embodiment of a quick-release animal leash device 100 while attached around a collar 5 of an animal 10 of the present invention in accordance with the disclosed architecture. It should be noted that one of the fasteners 122,132 is preferably positioned near the middle of the body 110. In this manner, the fasteners 122,132 can be unsecured easily while a user is standing, thereby eliminating the need to bend over to remove the leash from a collar 10 like with existing animal collars. Once unfastened, the device 100 can simply be pulled out from under the collar 10.

The second end 150 of the device 100 is comprised of at least one loop 160. The loop 160 allows the device 100 to be easily held. In one embodiment, the loop 160 is of a fixed circumference.

In another embodiment, the loop 160 is adjustable in circumference. This allows the loop 160 to fit a plurality of wrist sizes. In this embodiment, the loop 160 is adjustable via at least one loop fastener 162. The fastener 162 is preferably an adjustable sliding fastener, but may be any fastener type known in the art.

The loop 160 may also be comprised of at least one grip area 164. In one embodiment, the grip area 164 is comprised of a padding for comfort. The padding may be, but is not limited to, polyurethane foam, polyester foam, ethafoam, memory foam, lux foam, rebond foam, latex foam, etc., or any type of padding or foam known in the art.

In another embodiment, the grip area 164 may be textured with a recessed or raised texture or may be non-textured. In this embodiment, the grip area 164 is preferably made from a non-slip material that improves grip such as, but not limited to, silicone, latex, neoprene, EPDM, PVC foam, polyethylene, sponge rubber, silicone foam, urethane, cork, ridged and/or recessed rubber, felt, acrylic, polyester & SBR, etc. In this manner, the loop 160 does not easily slip out of a user’s hand during use.

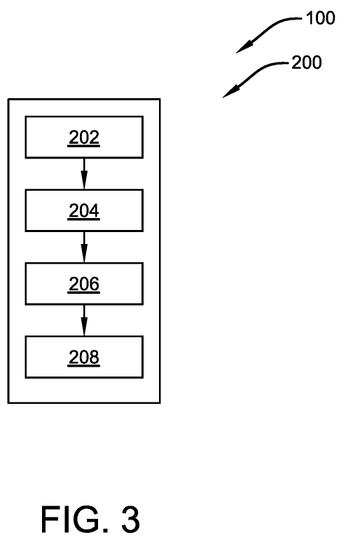

FIG. 3 illustrates a flowchart of a method of using one 200 potential embodiment of a quick-release animal leash device 100 of the present invention in accordance with the disclosed architecture. The device 100 is also comprised of a method of use 200. First, the body 110 is placed underneath and through a collar 10 on an animal 5 [Step 202]. Then, the body 110 is pulled toward the loop 160 [Step 204]. Next, the body 110 is secured to itself (and around the collar 10) by fastening the fastener 132 of the bottom surface 130 to the fastener 122 of the top surface 120 [Step 206]. Once a user desires to remove the device 100 from a collar 10, they can then separate the fasteners 122,132 and pull the body 110 out from between the collar 10 and the animal 5 by pulling the loop 160 and/or body 110 [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “quick-release animal leash device” and “device” are interchangeable and refer to the quick-release animal leash device 100 of the present invention.

Notwithstanding the foregoing, the quick-release animal leash device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the quick-release animal leash device 100 as shown in the FIGS. are for illustrative purposes only, and that many other sizes and shapes of the quick-release animal leash device 100 are well within the scope of the present disclosure. Although the dimensions of the quick-release animal leash device 100 are important design parameters for user convenience, the quick-release animal leash device 100 may be of any size, shape, and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A quick-release animal leash device comprising:
a body comprised of a first end, a second end, a top surface and a bottom surface;
a first fastener;
a second fastener;
a ring; and
a loop.

2. The quick-release animal leash device of claim 1, wherein the first fastener is comprised of a hook fastener.

3. The quick-release animal leash device of claim 1, wherein the first fastener is comprised of a loop fastener.

4. The quick-release animal leash device of claim 1, wherein the first fastener is positioned on the top surface.

5. The quick-release animal leash device of claim 4, wherein the second fastener is positioned on the bottom surface.

6. A quick-release animal leash device comprising:
a body comprised of a first end, a second end, a top surface and a bottom surface;
a first fastener positioned on the top surface;
a second fastener positioned on the bottom surface;
a ring; and
a loop comprised of a grip area.

7. The quick-release animal leash device of claim 6, wherein the body is comprised of a leather, a nylon, a chain or a cotton material.

8. The quick-release animal leash device of claim 6, wherein the body is comprised of a reflective material.

9. The quick-release animal leash device of claim 6, wherein the body is comprised of a phosphorescent material.

10. The quick-release animal leash device of claim 6, wherein each of the first fastener and the second fastener is comprised of a hook fastener, a loop fastener, a snap-button fastener, or a zipper fastener.

11. The quick-release animal leash device of claim 6, wherein the grip area is comprised of a padding.

12. The quick-release animal leash device of claim 6, wherein the grip area is comprised of a raised texture.

13. A quick-release animal leash device comprising:
a body comprised of a first end, a second end, a top surface and a bottom surface;
a first fastener positioned on the top surface;
a second fastener positioned on the bottom surface;
a ring; and
a loop comprised of a grip area.

14. The quick-release animal leash device of claim 13, wherein the loop is adjustable in circumference.

15. The quick-release animal leash device of claim 14, wherein the loop is comprised of a loop fastener.

16. The quick-release animal leash device of claim 15, wherein the loop fastener is comprised of a sliding buckle.

17. The quick-release animal leash device of claim 13, wherein the grip area is comprised of a recessed texture.

18. The quick-release animal leash device of claim 13, wherein the grip area is comprised of a non-slip material.

19. The quick-release animal leash device of claim 13, wherein the body is comprised of an elastic material.

20. The quick-release animal leash device of claim 13, wherein the first fastener is positioned in a middle of the body on the top surface.
